(19) United States
(12) Patent Application Publication
(10) Pub. No.: US 2024/0304032 A1
(43) Pub. Date: Sep. 12, 2024

(54) SYSTEM FOR THE VERIFICATION OF THE IDENTITY OF A PERSON BY FACIAL RECOGNITION

(71) Applicants: EURONOVATE SA, Maroggia (CH); SUPSI (Scuola Universitaria Professionale della Svizzera Italiana), Istituto Sistemi informativi e, Manno (CH)

(72) Inventors: Luigi MERONI, Maroggia (CH); Alberto GUIDOTTI, Maroggia (CH); Giacomo PORETTI, Manno (CH); Vanni GALLI, Manno (CH); Michela PAPANDREA, Manno (CH); Andrea QUATTRINI, Manno (CH)

(73) Assignees: EURONOVATE SA, Maroggia (CH); SUPSI (Scuola Universitaria Professionale della Svizzera Italiana), Istituto Sistemi Informativ e, Manno (CH)

(21) Appl. No.: 18/264,585

(22) PCT Filed: Feb. 4, 2022
(86) PCT No.: PCT/IB2022/050996

§ 371 Date: Aug. 8, 2023

(30) Foreign Application Priority Data
Feb. 8, 2021 (IT) 102021000002744

(51) Int. Cl. G06V 40/40; G06V 10/778; G06V 10/82; G06V 40/16

(52) U.S. Cl. CPC G06V 40/40; G06V 10/778; G06V 10/82; G06V 40/165; G06V 40/171; G06V 40/172

(57) ABSTRACT

A system for the verification of the identity of a person by facial recognition comprising a processor and/or a processing device/unit/component/element (or the like) configured to identify at least one distinguishing feature from images representative of the gaze orientation of the face of a user to be verified. Identity verification is performed by classifying the gaze movement of said user to be verified by assigning it a veracity index based on the correlation between the distinguishing feature of the images, the position of a/the processor and/or an acquisition device/unit/component/element (or the like) and/or the face of the user to be verified, the distinguishing feature of training images, and the acquisition position associated with each training image.

### TECHNICAL FIELD

The present invention relates to a system for the verification of the identity of a person by facial recognition.

### BACKGROUND ART

Nowadays, more and more personal information and/or sensitive data are stored in personal devices, or in remote servers, to be accessed by a user through special services. For example, personal devices, such as smart phones, smart watches and computers, can be used to carry out financial transactions or to connect to applications containing potentially dangerous banking data if not properly protected.

In order to protect the sensitive data of a user, it is known that there are authentication systems which are able to verify the digital identity of the user through different methods, from the simple use of passwords, unlock codes or PIN, to more sophisticated systems that also use biometric information such as, e.g., the fingerprint, the timbre and tone of voice, or the physiognomy of the face.

Because an authentication system requires a degree of protection which correlates with the sensitivity of the data provided by the service, authentication systems based on biometric information are among the most widely used because they are more complex to replicate and easier to use.

Facial authentication is a biometric authentication technology capable of recognizing the identity of a user's face through various techniques such as e.g. using a camera to capture the user's face.

It should be noted, however, that the known techniques of facial authentication are not always able to distinguish whether the face of the user captured by the camera is real or consists of a reproduction thereof, e.g. on a screen or on paper, thus resulting easily circumvented by potential fraudsters able to deceive the various recognition systems.

These types of thefts (so-called “computer thefts”) are even more simplified by the large availability of personal information available online, thus facilitating “spoofing” type attacks.

For example, a first type of spoofing, called “print attack”, involves placing the printing of an image of the user's face in front of the camera.

A known solution to overcome this drawback, for example described by Pan in the publication “Eyeblink based Antispoofing detection in Face Recognition from a generic Webcam” in 2007, exploits the involuntariness and the necessity of the blink, not reproducible from a static image, through the acquisition of a video of the user's face to recognize the movement of the eyelids. This solution, however, is not without problems as it is a rather slow operation and depends on the duration of the eyelash blink that usually occurs every 10-15 seconds. Other types of spoofing involve the use of a video reproduction of the user's face (so-called “replay attack”) or the creation of a mask (so-called “mask attack”). To overcome these and other types of spoofing, various solutions have been developed.

The verification of truthfulness of the fraudulent images provided can e.g. be carried out by using descriptors, as set out e.g. by Määtta in the publication “Face spoofing detection from single images using micro textures” in 2011, by Huang in “Local Binary Patterns and Its Application to Facial Image Analysis: A Survey” or Chingovska in “On the Effectiveness of Local Binary Patterns in Face Anti-Spoofing” in 2012. In such solutions, sub-portions of images are analyzed with the purpose of identifying the differences between the image of a real person and a counterfeit one. Such a solution may involve using specially trained automatic learning algorithms to classify the image as real or counterfeit. Since the identification of the differences is carried out on a single image, such a solution allows for extremely fast processing and response times. However, although the verification of truthfulness is particularly accurate on images extracted from the training dataset of the algorithm, it was ascertained that, if carried out on a sampling of different images, accuracy is extremely low. This solution has therefore problems of generalization, resulting ineffective in a context of real application.

Other known solutions for the verification of the identity of a user are, for example, described by De Hann in “Robust Pulse Rate from Chrominance-Based rPPG” in 2013 and by Wangg in “A Novel Algorithm for Remote Plethysmography: Spatial Subspace Rotation” in 2015. These techniques involve analyzing the video of a user's face to extract their heart rate based on the amount of light incident on a vascularized tissue. In fact, the amount of light scattered and/or reflected by a vascularized tissue is proportional to the volume of blood flowing in the blood vessel. Usually, this technology is particularly effective if accompanied by its own light source, such as e.g. a LED light, and if the sensor for the measurement is placed in direct contact with the tissue, such as in the case of wristwatches. If this is not the case, on the other hand, the technology is unreliable because it is strongly influenced by ambient light. Furthermore, McDuff in “The Impact of Video Compression on Remote Cardiac Pulse Measurement” in 2017 showed how the compression required to stream the video to a remote server destroys and masks the signal in question. Other noteworthy solutions are described in the publications by Määtta in “Face spoofing detection from single images using micro textures” in 2011, by Liu in “Learning Deep Models For Face Anti-Spoofing: Binary or Auxiliary Supevision” in 2018, or by Ebihara in “Specular- and Diffuse-reflection-based Face Spoofing Detection for Mobile Devices” in 2019. However, while these solutions allow for the verification and counteracting of some counterfeits, they are not extensible to the full range of fraud types.

### DESCRIPTION OF THE INVENTION

By virtue of the aforementioned issues, the Applicant has thought to improve the known facial recognition technologies by developing a system for the verification of the truthfulness wherein the correlation is exploited between the change in the orientation of the gaze of the face to be verified and the displacement of the device wherein the facial recognition is implemented.

On the basis of this correlation it is thus possible to classify a user by means of an appropriate veracity index.

Accordingly, the present invention relates to a system for the verification of the identity of a person according to the claim 1 having structural and functional characteristics such as to meet the aforementioned requirements while at the same time obviating the drawbacks discussed above with reference to the prior art.

Another object of the present invention relates to a method for the verification of the identity of a person by facial recognition having the characteristics of claim 8.

### BRIEF DESCRIPTION OF THE DRAWINGS

Other characteristics and advantages of the present invention will become more apparent from the description of a preferred, but not exclusive, embodiment of a system for the verification of the identity of a person by facial recognition, illustrated by way of an indicative, yet non-limiting example, in the accompanying tables of drawings wherein:

FIGS. 1 and 2 show schematic perspective views of a counterfeit and authentic user's face, respectively,

FIGS. 3 and 4 are schematic frontal views of the eyes of a user's face with gaze directed in two different directions,

FIG. 5 is a view of a block diagram of the system according to the invention.

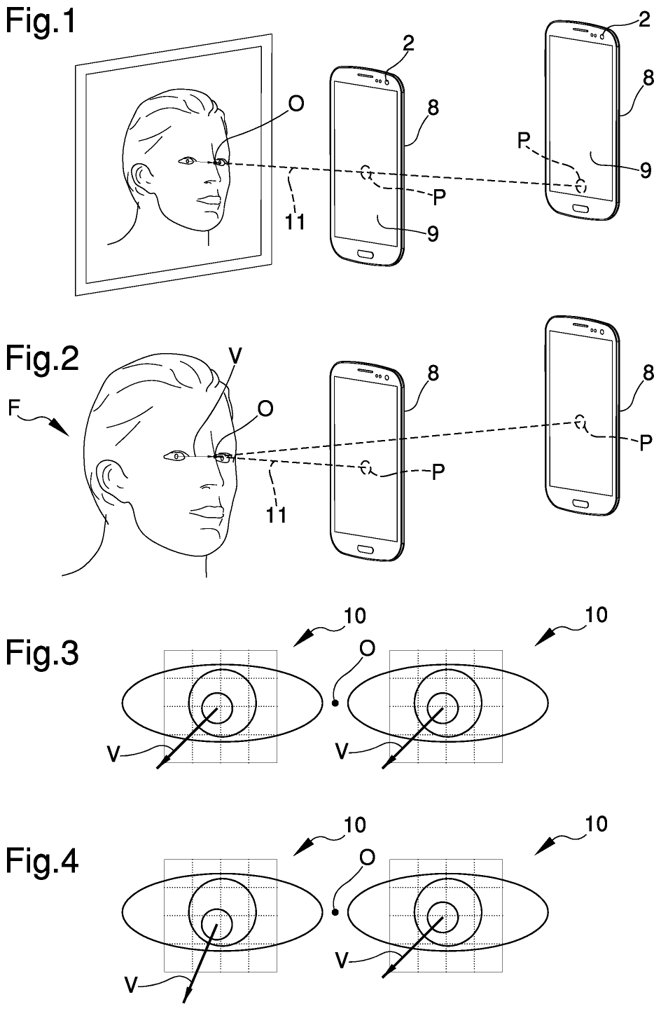

### EMBODIMENTS OF THE INVENTION

With particular reference to these figures, reference numeral 1 globally indicates a system for the verification of the identity of a person by facial recognition.

The system 1 can be associated with one or more facial recognition technologies able to identify in a digital image a face F by means of predefined automatic learning algorithms associated with special previously trained neural networks.

According to the invention, the system 1 allows the face F detected by facial recognition to be classified by means of a veracity index I representative of whether the face F belongs to a real user or to a counterfeit image.

In detail, the system 1 comprises acquisition means 2 adapted to acquire at least a first image IMG1 and a second image IMG2 of the face F of a user. In this case, the acquisition means 2 may be of the type of a camera to acquire video contents of the face F of the user and to generate a video signal comprising a plurality of images/frames and wherein the acquisition means 2 are possibly mounted on board a portable device 8 of a user (e.g., a smart phone).

Conveniently, the system 1 comprises detection means 3 adapted to detect the position of the acquisition means 2 and/or of the face F of the user in a predefined reference system.

The system 1 is also provided with a database 4 for the storage of the acquired images IMG1, IMG2 and of the position of the acquisition means 2 detected by the detection means 3.

The database 4 may also contain at least a first IMG_TR1 and a second IMG_TR2 training image both representative of a genuine or counterfeit face. In such images IMG_TR1, IMG_TR2 at least one distinguishing training feature CD(P) representative of the gaze orientation of the face and an acquisition position associated with each training image IMG_TR1, IMG_TR2 are identified.

In the remainder of the description and in the subsequent claims, the term “acquisition position” of an image refers to the location of the acquisition means 2 or of other types of means, such as e.g. cameras mounted on the user's smart phone 8, at the time/instant of acquiring an image.

The term “gaze orientation” refers to the direction in which the view of the eyes is directed. Gaze orientation can be measured by means of a versor V originating in each eye of the user's face F.

Advantageously, the system 1 comprises processing means M in signal communication with the acquisition means 2, the detection means 3 and the database 4, to receive the acquired images IMG1, IMG2, the training images IMG_TR1, IMG_TR2, and the acquisition positions.

The processing means M comprise an identification module 5 configured to identify from each acquired image IMG1, IMG2 at least one distinguishing feature CD1, CD2 representative of the gaze orientation.

In detail, the processing means M receive at input a video signal from the acquisition means 2 and the identification module 5 processes the video signal to return at output a signal representative of at least one distinguishing feature CD1, CD2 for each acquired image IMG1, IMG2.

Advantageously, the processing means M comprise a classifier 6 configured to classify the gaze movement of the user to be verified by assigning it a veracity index I based on the correlation between:
at least one distinguishing feature CD1, CD2 of the acquired images IMG1, IMG2,
the position of the acquisition means 2 and/or of the face F of the user,
the distinguishing feature CD(P) of the training images IMG_TR1, IMG_TR2, and
the acquisition position associated with each training image IMG_TR1, IMG_TR2.

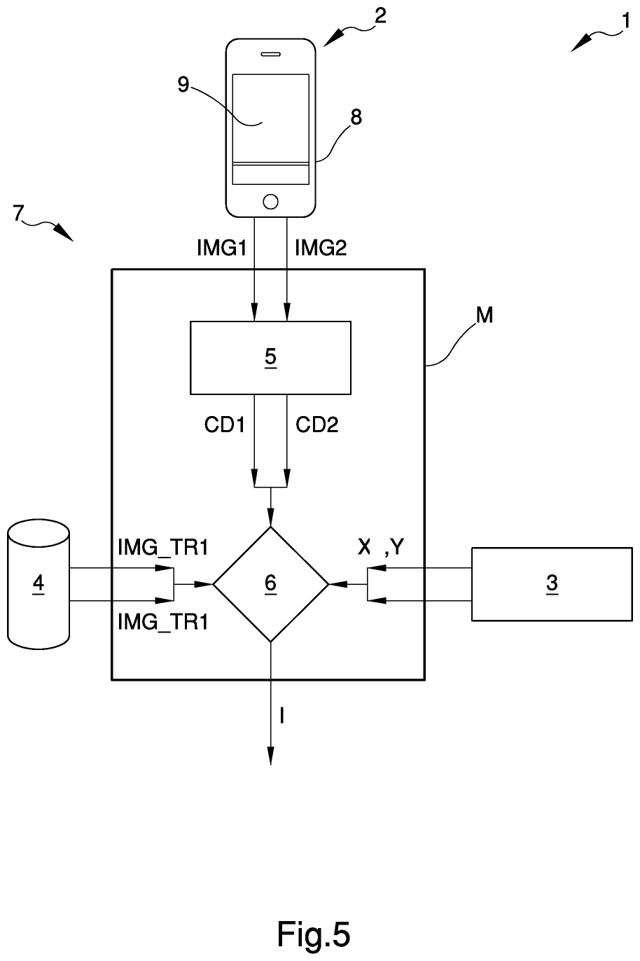

As observable from the FIG. 5, the system 1 comprises a piece of architecture 7 configured to put in signal communication the processing means M, the acquisition means 2, the detection means 3 and the database 4. The communication between the elements of the architecture 7 may be managed, e.g., by means of appropriate software mounted on appropriate hardware.

In one or more embodiments, the architecture 7 is implemented on a device 8, such as e.g. a smart phone or a tablet.

Conveniently, the device 8 comprises a substantially flat screen 9 by means of which the contents generated by the device 8 itself and/or by the system 1 can be displayed.

In one or more embodiments, the acquisition means 2 are arranged substantially in the same plane as the screen 9 and, preferably, are arranged above the latter. In this way, the device 8 may be placed frontally to the user to acquire video/photographic contents of the user's face F while generating contents viewable by the user on the screen 9.

As anticipated above, the system 1 may be associated with a facial recognition. For this purpose, the processing means M are configured to analyze the acquired images IMG1, IMG2 and to detect within the aforementioned images the representation of a face F, preferably the face F of the user to be authenticated.

In particular, the processing means M analyze the image by means of a predefined automatic learning (or so-called “machine learning” or “deep learning”) algorithm, preferably of the regression type, by means of which it is possible to extract an identification model of the remarkable points (or so-called “landmarks”) of the face F.

By remarkable points or landmarks is meant a succession of substantially punctual areas, usually sixty-eight, which identify the perimeter of the face F, the top of the chin, the outer edge of each eye, the inner edge of each eyebrow, etc.

In particular, the processing means M are connected to at least one neural network, preferably of the convolutional type, previously trained for the purpose of obtaining the identification model of the remarkable points of the face F. Preferably, the neural network is trained to classify the identified face F as belonging to the user to be verified.

In one or more versions, the processing means M are configured to extract from each acquired image IMG1, IMG2 at least a first and a second area of interest 10, each comprising the remarkable points which are representative of a first and of a second eye of the face F, respectively. In particular, as shown in FIGS. 3 and 4, each area of interest 10 comprises a plurality of pixels arranged in a matrix around the remarkable points of the respective eye. Preferably, the matrix of pixels is of the 60×36 type.

Preferably, the processing means M are configured to verify whether the pupil or blink of the user's eye to be verified is represented in each acquired image IMG1, IMG2 and, if not, to generate an error signal.

Furthermore, the processing means M generate a signal representative of each area of interest 10 that is received by the identification module 5 to analyze it and identify the possible presence of at least one distinguishing feature CD1, CD2, as described in detail below in the present description.

Additionally, the processing means M may be configured to identify the orientation of the face F by means of the analysis of the remarkable points obtained from the facial recognition, e.g. by means of the analysis of the mutual position of the latter. Preferably, the orientation of the face F is classified by means of the calculation of an orientation matrix, i.e., a matrix which, if applied to the reference system of the acquisition means, causes it to coincide with the reference system of the face, e.g., by means of Perspective-n-Point technology as described, e.g., in Fischer's publication entitled “RT-Gene: Real Time Eye Gaze Estimation in Natural Environments” in 2018, the contents of which are incorporated herein by reference, by means of which, given a correspondence between at least two remarkable points extracted from the face, the position of the face F in a Cartesian reference system centered in the acquisition means 2 can be calculated.

In one or more versions, the processing means M are configured to verify whether faces other than the user's face F to be verified are present in each acquired image IMG1, IMG2. If so, the processing means M generate an error signal.

In one or more versions, the processing means M are configured to verify whether the face F of the user to be verified is present in each acquired image and, if not, to generate an error signal.

Additionally, the processing means M may be configured to verify whether the face F of the user to be verified is always the same in each acquired image IMG1, IMG2 and, if not, to generate an error signal.

In the event of the processing means M generating at least one error signal, the system 1 prompts the user for a new image acquisition in order to continue with the gaze orientation classification.

In one or more versions, the distinguishing feature CD1, CD2 may be classified by a versor V which identifies the orientation thereof in a Cartesian reference system.

To this end, the processing means M are configured to associate with the distinguishing feature CD1, CD2 of each acquired image IMG1, IMG2 a versor V representative of the gaze orientation. In detail, the identification module 5 receives at input the signal representative of the gaze orientation and of each area of interest 10, processes the signals by means of a special automatic learning algorithm (previously trained by means of an appropriate dataset, in order to classify the identified distinguishing features CD1, CD2) and return at output a signal representative of the versor V of gaze orientation.

Advantageously, once the versor V is identified, the processing means M are configured to classify the distinguishing feature CD1, CD2 of each acquired image IMG1, IMG2 by means of the point of intersection P of a vector 11, having as origin a point of reference O and direction of the versor V, with the screen 9. Preferably, in each acquired image IMG1, IMG2, the point of reference O is located in the center of the eyes of the represented face F.

For this purpose, the processing means M are configured to determine the position of the face represented in an image as a function of the position of the acquisition means 2. In this way, the processing means M may analyze the acquired images IMG1, IMG2 to identify, in each acquired image IMG1, IMG2, the position of the point of reference O with respect to the screen 9 of the device 8.

Conveniently, the point of reference O in the first acquired image IMG1 is calculated by means of the method described above, while in the remaining acquired images IMG2 it is calculated by knowing how the position of the device 8 varies with respect to the acquisition position of the first acquired image IMG1.

For this purpose, the detection means 3 are configured to calculate the distance between the acquisition position of the second acquired image IMG2 and the acquisition position of the first acquired image IMG2 to determine the position of the point of reference O with respect to the acquisition position of the second acquired image IMG2.

Specifically, in use, in order to carry out the classification, the user moves the device from an initial position A to an end position B.

Preferably, the initial position A corresponds to the acquisition position of the first image IMG1, all other acquisition positions being calculated in a reference system having the origin at the initial position A.

Preferably, the device 8 is moved along a substantially straight direction and perpendicular to the screen 9. In other words, the device 8 is moved away from and/or close to the face F of the user to be verified. A straight movement of the device 8 allows the system 1 to identify the orientation of the gaze more accurately than other movements. Such a straight movement in fact allows fully exploiting the resolution of the camera 2 since, during the movement, the plane of the face F remains substantially parallel to the plane of the camera 2. Conversely, if the tilting angle between the position of the face F and of the camera 2 varied substantially, the estimation of the gaze direction would be less accurate. It cannot, however, be ruled out that the device 8 could be moved in different ways.

Preferably, the duration of the displacement of the device 8 between the initial position A and the end position B is a few seconds.

Conveniently, the detection means 3 comprise an inertial unit of measurement for measuring the velocity and acceleration of the displacement of the device 8 in a Cartesian reference system. For this purpose, the inertial unit of measurement comprises at least an accelerometer, a gyroscope and a magnetometer. In particular, by means of these components, the detection means 3 may generate a signal representative of the acceleration and velocity of displacement of the device 8. Preferably, the detection means 3 are configured to measure the acceleration and velocity of displacement of the device 8 by means of a predefined frequency sampling. Preferably, the sampling is carried out at a frequency comprised between 100 Hz and 200 Hz.

Finally, the processing means M are configured to analyze the signals received from the detection means 3 to calculate the distance traveled by the device 8 to move from the initial position A to the end position B. Specifically, the detection means 3 calculate the displacement of the device 8 by means of a double integration on the acceleration signal measured by the detection means 3.

It is useful to note that the acceleration signal measured by the detection means 3 may usually include a number of interfering signals, generated by the presence of unwanted external forces such as gravity, which overlap with the useful signal.

Furthermore, since the device 8 is usually moved by a real user, the displacement of the device 8 is not perfectly linear and the measured acceleration may comprise a non-negligible tilting/rotation component that, when added to the rest, generates an error in the calculation of the displacement of the device 8. This issue can be fixed by filtering the acceleration signal measured by the detection means 3 from the presence of any interfering signals. For this purpose, the processing means M are configured to subtract the gravity signal from the representative acceleration signal, preferably by means of, e.g., a high-pass filter or a notch filter, and to reduce the noise by means of a filter, preferably a Gaussian filter or a Kalman filter.

Once the displacement of the device 8 from the initial position A has been calculated, the position of the device 8 and the position of the point of reference O with respect to the screen 9 of the device can be known in each acquired image IMG1, IMG2.

At this point, the processing means M can calculate the point of intersection P between the vector 11 having its origin at the point of reference O and direction of the versor V with the screen 9 of the device 8 and classify the distinguishing feature CD of the gaze orientation by means of the X, Y coordinates of the point of intersection P.

Substantially, the processing means M use the co-planarity values between the position of the camera 2 and the screen 9 so that during an acquisition, e.g., a video recording, the analysis is performed on a sub-area of the screen 9 where generally a real user tends to focus. Therefore, the system 1 of the invention involves moving the device 8 with respect to the face, so that the movement made can then be correlated to the variation in gaze and can be analyzed where the user places their attention.

Once the distinguishing feature CD of each acquired image IMG1, IMG2 has been classified, the processing means M takes at input the coordinates X, Y of the points of intersection P of each acquired image IMG1, IMG2 and calculates one or more statistical values of their distribution on the screen 9, such as e.g., the nearest value around a mean value (so-called “centroid”).

Advantageously, the processing means M are configured to classify the gaze movement of the user to be verified by means of an automatic learning algorithm. In detail, the processing means M are connected to at least one neural network previously trained by means of training points of intersection P of the training images IMG_TR1, IMG_TR2 in order to obtain a classification logic based on the correlation between the points of intersection P and the training points of intersection to associate the face F to be verified with the veracity index I.

Preferably, the classification of the gaze orientation is performed by assigning a veracity index I based on the correlation of the statistical data of the acquired images IMG1, IMG2 with the statistical data of the training images IMG_TR1, IMG_TR2.

In detail, the classifier 6 is previously trained, preferably using a supervised technique, on a dataset created on purpose. For example, the training can be performed by analyzing a sequence of training images IMG_TR that simulate the gaze shift of the represented face as the position of the device that is acquiring the training images IMG_TR1, IMG_TR2 changes, by calculating the points of intersection P of each training image IMG_TR1, IMG_TR2 using the aforementioned method.

In one or more versions, the training can be performed by associating with a sequence of training images IMG_TR1, IMG_TR2 the statistical parameters of the calculated points of intersection P so that the neural network can build an appropriate classification logic based on these statistical data.

In one or more versions, the system 1 may provide for the removal of data containing a predetermined amount of noise. For this purpose, the processing means M are configured to remove the points of intersection P whose computation has been affected by a noise component above a predetermined threshold.

In one or more embodiments, the system 1 may comprise an app to be installed on the user's smart phone which instructs the latter on the sub-area (e.g., an oval) of the screen to be viewed while moving from position A to position B.

It has in practice been ascertained that the described invention achieves the intended objects and in particular the fact is emphasized that, by means of the system, it is possible to verify whether an identified face belongs to a real user.

1) A system for verification of an identity of a person by facial recognition, the system comprising:
acquisition means adapted to acquire at least a first image and a second image representative of a face of a user to be verified,
detection means adapted to detect the position of the acquisition means and/or of the face of the user in a predefined reference system,
a database containing at least a first and a second training image of a training face in which the following is identified:
at least one distinguishing training feature representative of a gaze orientation, and
an acquisition position associated with each training image,
processing means in signal communication with said acquisition means, said detection means and said database and configured to receive said acquired images and said training images; wherein
said processing means are configured to:
identify at least one distinguishing feature from said acquired images representative of the gaze orientation of the face of said user to be verified,
classify the gaze movement of said user to be verified by assigning to said user a veracity index based on the correlation between
said at least one distinguishing feature of said acquired images,
said position of said acquisition means and/or said face of said user to be verified,
said at least one distinguishing feature of said training images, and
said acquisition position associated with each training image.

2) The system according to claim 1, wherein said acquisition means are mounted on board a portable device comprising at least one screen, said processing means being configured to use the co-planarity values between the position of said acquisition means and of the screen.

3) The system according to claim 2, wherein said processing means are configured to:
associate with said distinguishing feature of said acquired images a versor representative of the gaze orientation,
analyze said acquired images to identify, in each acquired image, the position of a point of reference with respect to said screen,
classify said distinguishing feature of each of said acquired images by means of a point of intersection of a vector, having as origin said point of reference and as direction of said vector, with said screen.

4) The system according to claim 3, wherein said detection means are configured to calculate the distance between the acquisition position of said second acquired image and the acquisition position of said first acquired image to determine the position of said point of reference with respect to the acquisition position of said second acquired image.

5) The system according to claim 4, wherein said classification is carried out on the basis of the correlation between said points of intersection of said acquired images and the points of training intersection of said training images.

6) The system according to claim 5, wherein said processing means are configured to classify the gaze movement of said user by means of an automatic learning algorithm, said processing means being connected to at least one neural network previously trained by means of said points of training intersection for the purpose of obtaining a classification logic based on the correlation between said points of intersection of said acquired images and said points of training intersection in order to associate with said face to be verified said veracity index.

7) The system according to claim 6, wherein said detection means comprise an inertial measurement system configured to measure the acceleration of the displacement of said detection means.

8) A method for the verification of an identity of a person by facial recognition, said method comprising:
a) having at least a first training image and a second training image of a training face wherein at least one distinguishing training feature representative of the gaze orientation is identified, and an acquisition position associated with each training image,
b) acquiring at least a first image and a second image representative of the face of a user to be verified,
c) identifying at least one distinguishing feature of each of said acquired images,
d) classifying the gaze movement of said user to be verified by assigning them a veracity index based on the correlation between said at least one distinguishing feature of said acquired imags, said position of said acquisition means and/or said face of said user to be verified, said at least one distinguishing feature of said training images, and said acquisition position associated with each training image.

9) The method according to the claim 8, said method further comprising:
e) having a portable device provided with acquisition means to acquire said first and second acquired images and a screen,
f) identifying, in each acquired image, the position of a point of reference with respect to said screen of said device, and associating with said distinguishing feature of each acquired image a versor,
g) classifying said distinguishing feature of each of said first and second acquired images by means of a point of intersection of a vector having as origin said point of reference and direction of said versor with said screen, and
in said classification phase d), said classification is carried out based on the correlation between said points of intersection of said acquired images and said points of intersection of said training images.

10) The method according to claim 9, said method further comprising:
h) having at least one neural network,
i) training said neural network by means of said at least first and second training images;
and wherein said phase of classifying d) is carried out based on the correlation between said points of intersection of said acquired images and said points of intersection of said training images.

11) The method according to claim 10, wherein that said phase of classifying the gaze movement of said user is carried out by moving said portable device between an initial position and an end position.

12) The system according to claim 3, wherein said classification is carried out on the basis of the correlation between said points of intersection of said acquired images and the points of training intersection of said training images.

13) The system according to claim 1, wherein said detection means comprise an inertial measurement system configured to measure the acceleration of the displacement of said detection means.

14) A non-transitory computer readable medium having instructions stored thereon, such that when the instructions are read and executed by one or more processors, said one or more processors is configured to perform said method according to claim 8.

15) A system for verification of an identity of a person by facial recognition, the system comprising:
an acquisition device adapted to and/or configured to acquire at least a first image and a second image representative of a face of a user to be verified,
a detector adapted to detect the position of the acquisition device and/or of the face of the user in a predefined reference system,
a database containing at least a first and a second training image of a training face in which the following is identified:
at least one distinguishing training feature representative of a gaze orientation, and
an acquisition position associated with each training image,
one or more processor(s) in signal communication with said acquisition device, said detection device and said database and configured to receive said acquired images and said training images; wherein
said one or more processor(s) are configured to:
identify at least one distinguishing feature from said acquired images representative of the gaze orientation of the face of said user to be verified,
classify the gaze movement of said user to be verified by assigning to said user a veracity index based on the correlation between
said at least one distinguishing feature of said acquired images,
said position of said acquisition device and/or said face of said user to be verified,
said at least one distinguishing feature of said training images, and
said acquisition position associated with each training image.
